(19) United States
(12) Patent Application Publication
(10) Pub. No.: US 2013/0037603 A1
(43) Pub. Date: Feb. 14, 2013

(54) Method of Forming a Bonded Structure

(71) Applicants: Won Kyoung Choi, Singapore (SG); Chiraharikathu Veedu Sankarapillai Premachandran, Singapore (SG); Ling Xie, Singapore (SG); Ebin Liao, Singapore (SG); Siong Chiew Joe Ong, Singapore (SG); Kewu Bai, Singapore (SG)

(72) Inventors: Won Kyoung Choi, Singapore (SG); Chiraharikathu Veedu Sankarapillai Premachandran, Singapore (SG); Ling Xie, Singapore (SG); Ebin Liao, Singapore (SG); Siong Chiew Joe Ong, Singapore (SG); Kewu Bai, Singapore (SG)

(73) Assignee: Agency for Science ,Technology and Research

(21) Appl. No.: 13/578,407

(22) PCT Filed: Feb. 10, 2010
(86) PCT No.: PCT/SG2010/000048

§ 371 Date: Oct. 23, 2012

(51) Int. Cl. B23K 1/20

(52) U.S. Cl. 228/203

(57) ABSTRACT

In an embodiment, a method of forming a bonded structure is provided. The method may include forming at least one first under bump metallurgy (UBM) structure on a first substrate, forming a first gold layer on the at least one first under bump metallurgy structure; forming a tin layer on the first gold layer, forming an indium layer on the tin layer, forming an inhibition layer configured to inhibit oxygen penetration on the indium layer, and forming at least one second under bump metallurgy structure on a second substrate, forming s second gold layer on the at least one second under bump metallurgy structure; and bringing the inhibition layer into contact with the second gold layer at a predetermined temperature to form a resultant intermetallic structure between the first substrate and the second substrate thereby bonding the first substrate to the second substrate and forming the bonded structure.

### TECHNICAL FIELD

Embodiments relate to a method of forming a bonded structure.

### BACKGROUND

Three-dimensional (3D) integration has been a main stream to be developed by industries and research institutes in order to manufacture multifunctional and high performance electronic products in a small form factor for different applications. Some integration methods may include copper to copper (Cu—Cu) bonding or copper to tin (Cu—Sn) bonding. These bonding methods may utilize a high temperature above 300° C. for interconnecting different devices or wafers in a vertical fashion. The high bonding temperature may degrade the performance and the sensitivity of the respective optical Micro-Electro-Mechanical Systems (MEMS), photonics and radio frequency (RF) devices. Therefore, a low temperature bonding below 200° C. may be necessary for vertically integrating heterogeneous systems such as multifunctional devices into a System in Package (SiP).

An example of a relatively low temperature bonding may be a transient liquid phase (TLP) bonding method. The transient liquid phase bonding method may allow stacking of the devices vertically with reduced thermal damages and stresses. Since joints between the respective devices form robust intermetallic (IMC) interconnects with high re-melting temperature after bonding of a second layer to a first layer below 200° C., a third layer may be stacked up subsequently at about the same temperature of below 200° C. As an example, an indium (In) layer with nickel (Ni), Cu or gold (Au) may be used for the low temperature bonding in 3D integration, since the In layer may have a low melting temperature of about 156° C. However, because of a relatively fast interdiffusion between the In layer and pad metals for example, Cu, Ni, Au, even at a room temperature, the relatively thin In layer may be susceptible to be transformed shortly to an alloy layer with a higher melting temperature resulting in a required higher bonding temperature. As a result, bonding with the thin In layer may need to be carried out at a temperature even higher than at 200° C.

Therefore, there is a need for an alternative method of forming a bonded structure which may carried out at a relatively low bonding temperature and may achieve a high remelting temperature thereafter.

### SUMMARY

In various embodiments, a method of forming a bonded structure is provided. The method may include forming at least one first under bump metallurgy (UBM) structure on a first substrate, forming a first gold layer on the at least one first under bump metallurgy structure; forming a tin layer on the first gold layer, forming an indium layer on the tin layer, forming an inhibition layer configured to inhibit oxygen penetration on the indium layer, forming at least one second under bump metallurgy structure on a second substrate; forming a second gold layer on the at least one second under bump metallurgy structure; and bringing the inhibition layer into contact with the second gold layer at a predetermined temperature to form a resultant intermetallic structure between the first substrate and the second substrate thereby bonding the first substrate to the second substrate and forming the bonded structure.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments of the invention are described with reference to the following drawings, in which:

FIG. 1 shows a flowchart illustrating a method of forming a bonded structure according to an embodiment;

FIG. 2A shows a cross-sectional view of a first substrate and a second substrate before bonding the first substrate to the second substrate according to an embodiment; FIG. 2B shows a cross-sectional view of a bonded structure after bonding the first substrate to the second substrate according to an embodiment;

FIG. 3 shows a scanning electron microscope (SEM) image of a bonded structure according to an embodiment;

FIG. 4 shows a transmission electron microscope (TEM) image of a bonded structure according to an embodiment;

FIG. 5 shows a X-ray diffraction (XRD) of an unbonded structure after a duration of about 6 months according to an embodiment;

FIG. 6 shows a differential scanning calorimetry (DSC) of a bonded structure according to an embodiment;

FIG. 7 shows a cross-sectional view of a bonded structure with three substrates, each substrate stacked on top of another substrate via respective resultant intermetallic structures according to an embodiment;

FIG. 8 shows thermal cycling test results of respective bonded structures at different number of cycles according to an embodiment;

FIG. 9 shows three-dimension integration results of a bonded structure according to an embodiment;

FIG. 10A shows a differential scanning calorimetry (DSC) of respective bonded structures according to an embodiment; FIG. 10B shows a thermomechanical analysis (TMA) of respective bonded structures according to an embodiment; FIG. 10C shows a gold-indium-tin ternary phase diagram according to an embodiment;

FIG. 11 shows an isothermal gold-indium-tin ternary phase diagram according to an embodiment; and

FIG. 12 shows a cross-sectional view of a first substrate and a second substrate before bonding the first substrate to the second substrate according to another embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The word “exemplary” is used herein to mean “serving as an example, instance, or illustration”. Any embodiment or design described herein as “exemplary” is not necessarily to be construed as preferred or advantageous over other embodiments or designs.

An embodiment may provide a method of forming a bonded structure. The method may include forming at least one first under bump metallurgy (UBM) structure on a first substrate, forming a first gold layer on the at least one first UBM structure, forming a tin layer on the first gold layer, forming an indium layer on the tin layer, forming an inhibition layer configured to inhibit oxygen penetration on the indium layer, and forming at least one second under bump metallurgy structure on a second substrate, forming a second gold layer on the at least one second under bump metallurgy structure, and bringing the inhibition layer into contact with the second gold layer at a predetermined temperature to form a resultant intermetallic structure between the first substrate and the second substrate thereby bonding the first substrate to the second substrate and forming the bonded structure.

In an embodiment, the combination of the Sn layer, the In layer and the inhibition layer may be termed the initial solder structure. The material composition of the initial solder structure may affect the composition of the resultant intermetallic structure.

In an embodiment, the inhibition layer may include a material selected from a group of materials consisting of gold (Au), silver (Ag), platinum (Pt), cobalt (Co). The inhibition layer may be configured to inhibit oxygen penetration.

In an embodiment, the at least one first under bump metallurgy structure may include a third gold layer.

In an embodiment, the first gold layer and the third gold layer may be formed as a single layer.

In an embodiment, the at least one first under bump metallurgy structure may further include a first titanium layer. However, the first titanium layer may also be optional.

In an embodiment, the first titanium layer may be positioned directly or indirectly on the first substrate.

In an embodiment, the third gold layer may be positioned directly or indirectly on the first titanium layer.

In an embodiment, the at least one second under bump metallurgy structure may include a fourth gold layer.

In an embodiment, the second gold layer and the fourth gold layer may be formed as a single layer.

In an embodiment, the at least one second under bump metallurgy structure may further include a second titanium layer. However, the second titanium layer may also be optional.

In an embodiment, the second titanium layer may be positioned directly or indirectly on the second substrate.

In an embodiment, the fourth gold layer may be positioned directly or indirectly on the second titanium layer.

In an embodiment, the material composition and dimensions of the first gold layer may be the same as the second gold layer. The material composition and dimensions of the third gold layer may be the same as the fourth gold layer. Similarly, the material composition and dimensions of the first titanium layer may be the same as the second titanium layer.

In an embodiment, the at least one first under bump metallurgy structure may be the same or different from the at least one second under bump metallurgy structure.

In an embodiment, the at least one first under bump metallurgy structure or the at least one second under bump metallurgy structure may include any suitable material or combination of materials or any suitable number of layers of material depending on design and user requirements.

In an embodiment, the first substrate may include silicon, glass, ceramic, plastic, silicon carbide (SiC), printed circuit board (PCB).

In an embodiment, the second substrate may include silicon, glass, ceramic, plastic, silicon carbide (SiC), printed circuit board (PCB).

In an embodiment, each of the first substrate or the second substrate may include a wafer or a die.

In an embodiment, the material and dimensions of the first substrate may be the same as the second substrate.

In an embodiment, the inhibition layer may include a thickness in the range of about 30 nm to 100 nm.

In an embodiment, the indium layer may include a thickness in the range of about 2t um to 4t um, where t≧0.5. For example, the indium layer may include a thickness in the range of about 1.0 um to 2 um.

In an embodiment, the tin layer may include a thickness in the range of about t um where t≧0.5. For example, the tin layer may include a thickness in the range of about 0.5 um. As a further example, the indium layer may include a thickness at least about two times the thickness of the tin layer.

In an embodiment, the first gold layer may include a thickness in the range of about 2t um to 3t um, where t≧0.5. For example, the first gold layer may include a thickness in the range of about 1 um to 1.5 um. As a further example, the first gold layer may include a thickness at least about two times the thickness of the tin layer.

In an embodiment, both the first gold layer, the second gold layer, the third gold layer and the fourth gold layer may react after bonding. Before bonding, there may be some diffusion of gold (Au) atoms into the Sn layer and at the same time there may also be some diffusion of gold (Au) atoms into the In layer.

In an embodiment, the first titanium layer may include a thickness in the range of about 50 nm to 200 nm, typically about 100 nm.

In an embodiment, the second gold layer may include a thickness in the range of about 1 um to 3 um.

In an embodiment, the second titanium layer may include a thickness in the range of about 30 nm to 200 nm, typically about 100 nm.

In an embodiment, the first gold layer may include a thickness at least two times the thickness of the tin layer.

In an embodiment, the indium layer may include a thickness at least two times the thickness of the tin layer.

In an embodiment, the first gold layer, the tin layer and the indium layer may include a thickness with a ratio selected from a group of ratios consisting of 2:1:3, 3:1;3, 2:1:4, 3:1:4.

In an embodiment, the resultant intermetallic structure may include a gold-indium-tin intermetallic. The gold-indium-tin intermetallic may be represented by AuInSn IMC or Aux(InSn)1-x (0.35≦x≦0.95).

In an embodiment, the resultant intermetallic structure may include a material with a melting point higher than each of the tin layer or the indium layer. The melting point of tin layer may be about 232° C. and the melting point of In layer may be about 156° C.

In an embodiment, the resultant intermetallic structure may include a thickness in the range of about 6t um to 8t um depending on the thickness of the initial solder structure. As an example, if t≧0.5, then the range of thickness for the resultant intermetallic structure may be about 3 um to 4 um.

In an embodiment, the predetermined temperature may be about 180° C. The predetermined temperature may be higher than the melting point of the In layer and lower than the melting point of the Sn layer. But the predetermined temperature may be selected such that the temperature is higher than the melting point of an intermediate compound formed when the Sn layer reacts with the In layer. The intermediate compound may be InₓSn_{y} with a melting point less than the melting point of the In layer.

In an embodiment, the method may further include forming a first height-compensation layer between the first titanium layer and the first gold layer. As an example, the first height-compensation layer may be initially be positioned between the first titanium layer and the first gold layer. After bonding, the first height-compensation layer may then be seen to be positioned between the first titanium layer and the resultant intermetallic structure (i.e. AuInSn solder layer). This first height-compensation layer may be used to increase height of the bonded structure where the subtrate topography may not be planar while keeping the thickness of the resultant intermatllic structure (i.e. solder thickness) within a specified ratio.

In an embodiment, the method may further include forming a third titanium layer between the first height-compensation layer and the first gold layer.

In an embodiment, the method may further include forming a second height-compensation layer between the second titanium layer and the second gold layer. The second height-compensation layer may be the same or different from the first height-compensation layer. As an example, the first height-compensation layer and the second height-compensation layer may include a similar material composition or thickness. In addition, the first height-compensation layer and the second height-compensation layer may also be configured to serve the same purpose.

In an embodiment, the method may further include forming a fourth titanium layer between the second height-compensation layer and the second gold layer.

In an embodiment, the second height-compensation layer may be the same as the first height-compensation layer.

In an embodiment, the first height-compensation layer may include a material selected from a group consisting of copper, tungsten, nickel or silver for example.

In an embodiment, the second height-compensation layer may include a material selected from a group consisting of copper, tungsten, nickel or silver for example.

In an embodiment, the first titanium layer may be the same or different from the second titanium layer. The first titanium layer may include the same thickness or material composition as the second titanium layer.

In an embodiment, the third titanium layer may be the same or different from the fourth titanium layer. The third titanium layer may include the same thickness or material composition as the fourth titanium layer.

In an embodiment, the first titanium layer, the second titanium layer, the third titanium layer and the fourth titanium may be the same. Each of the first titanium layer, the second titanium layer, the third titanium layer and the fourth titanium layer may include the same thickness or material composition.

In an embodiment, the first height-compensation layer may include a material selected from a group consisting of copper (Cu), tungsten (W), nickel (Ni) or silver (Ag) for example. Any other suitable materials may also be used.

In an embodiment, the second height-compensation layer may include a material selected from a group consisting of Cu, W, Ni or Ag, for example. Any other suitable materials may also be used.

In an embodiment, the respective thickness of the first height-compensation layer and the second height-compensation layer may be in a range of between about 2 um to about 50 um, typically about 10 um. The thickness may vary depending on the user and design requirements.

In an embodiment, a low temperature IMC based bonding (<about 200° C.) for three-dimensional (3D) IC and Micro-Electro-Mechanical Systems (MEMS) packaging may be disclosed.

In an embodiment, 3D chip-stacking technology may require repeated stacking of additional layers without remelting joints that may have been formed at lower levels of the stack. This may be achieved by IMC based bonding whereby intermetallic joints may be formed at a lower temperature and withstand subsequent higher temperature processes.

Solder bonding with low temperature thin solder layers, such as In, may be used to reduce the bonding temperature for 3D IC stacking and MEMS packaging.

The interdiffusion between the low temperature solder, In, and the UBM, Au or Cu may happen relatively quickly before bonding, which may result in AuIn or CuIn IMCs formation. This may cause higher bonding temperature or poor interconnect properties.

To prevent the interdiffusion before bonding, a diffusion controlling layer may be needed between In and UBM to slow down the interdiffusion as well as IMC formation and at the same time to provide void-free low temperature bonding.

In an embodiment, a low temperature bonding below about 200° C. with In-based solder (low melting point (M.P.)) may be disclosed. AuInSn intermetallics interconnects (high M.P of about >300° C.) may also be formed.

In an embodiment, a Sn layer may be used as a diffusion controlling layer and a solder. The Sn layer may be placed between an In layer and a Au layer. The Sn layer may control interdiffusion between the In layer and the Au layer and AuIn IMC formation before bonding. The Sn layer may reduce the melting temperature of the In and so it may accelerate a reaction between the solder (e.g. In layer and Sn layer) and UBM (e.g. Au layer) at the bonding temperature forming AuInSn IMC. Further, a part of the In layer may be replaced with the Sn layer, which may mean that a thinner In layer may be needed. It may also be good for lowering cost.

In an embodiment, the Sn layer may be used to control AuIn IMC growth and to lower the solder melting point for bonding.

In an embodiment, the initial solder layer structure may need to consider the final IMC composition, which may meet the requirement for 3D interconnects, such as high melting point (for example greater than about 300° C.), low electrical resistance, shear strength, continuity (without voids), reliable characteristics including high temperature storage (HTS), temperature cycling test (TCT) and high temperature (HT), drop impact.

In an embodiment, the respective solder layers may be fabricated by e-beam evaporation, sputtering and electroplating methods.

In an embodiment, a joint layer structure with Ti/Au/Sn/In stacks of which layer thickness ratio is Au:Sn:In=(2 to 3):1:(3 to 4) may be disclosed.

In an embodiment, a AuInSn IMC joint with high melting temperature above 300° C. after bonding may be formed at a low bonding temperature of less than or equal to about 180° C.

In an embodiment, a low temperature bonding with thin solder layer followed by formation of a high temperature phase may be disclosed.

In an embodiment, a relatively thin Sn layer may be added between In and Au. The Sn layer may be used to control In and Au interdiffusion and AuIn IMC formation. The Sn layer may help to lower the solder melting temperature to below about 156° C. for bonding. At a low temperature of below about 180° C., an uniform bonding may be made.

In an embodiment, the method of forming the bonded structure may be used in system in package (SIP) by chip to wafer (C2W) bonding method. It may also be used in copper coil stacks, 3D integration for example homogeneous IC stacking, heterogeneous stacking. It may be used in MEMS Packaging for example hermetic sealing. It may also be used in an image sensor module and photonics packaging.

In an embodiment, the solder layer may be used for micro bump formation of less than or equal to about 50 μm. The method of forming the bonded structure may also be used to stack up more than three layers.

In an embodiment, Sn may be used as a diffusion controlling layer to slow down the AuIn IMC growth so that the pure solder layer may be reserved. Sn addition may improve the In wetting property with the UBM so that no voids may be observed at the interface. Au may be used as the UBM to decide the final IMC phases. Sn may be used for the diffusion controlling layer, which may delay room temperature interdiffusion between Au and In and help IMC formation in bonding. Sn may help to improve the wetting property in bonding by reducing solder melting temperature. Bonding may be done shortly for about 20 s to about 40 s at about 180° C. in a die level, and for about 10 min in a wafer level.

In an embodiment, the method of forming the bonded structure may allow for an increased performance. The increased performance may be achieved by a controlled interdiffusion between In and Au. Cost may be reduced by decreasing In thickness. The bonding temperature may be lowered with higher remelting temperature. The process cycle time may be faster as no atmospheric control may be required. There may be a relatively wide process window for process control. These include low electrical resistance (<10 mΩ per 80 um bump), high bonding shear strength (20 to 50 MPa), thin interconnects height (<5 um), low thermal load due to low temperature process below 180° C., no underfill may be required, low bonding stress and higher reliability due to low Young's modulus compared with CuSn IMCs.

In an embodiment, the method of bonding or forming the bonded structure may be cost effective as reducing In layer thickness and removing underfill may result in reduced cost. Further, the cost process may be lower as no special atmosphere or equipment may be required.

Further, very thin IMC joint may reduce form factor and thermal stress

In addition, lower processing temperature of below about 180° C. may be beneficial for complicated system integration.

In an embodiment, the method of bonding or forming the bonded structure may yield comparable electrical and mechanical properties with AuInSn IMC and CuSn IMC. Further, the method of bonding or forming the bonded structure may be easily traceable by decapping and analyzing.

In an embodiment, an IMC composition may be Au_{0.35 to 0.95}(In_{0.75 to 0.95}Sn)_{0.05 to 0.75}. Some of Au may be replaced with Cu, Ni, Silver (Ag), Palladium (Pd), Platinum (Pt), Titanium (Ti), Chromium (Cr), Tungsten (W) depending on the UBM structure. The Au component in the IMC composistion may be contributed mainly by the first gold layer.

In an embodiment, the bonding temperature may be modified by adjusting the In and Sn compositions.

In an embodiment, the bonding temperature may be between about 118° C. to about 220° C.

In an embodiment, the remelting temperature may be above about 300° C.

In an embodiment, there may be several layers of metallization underneath Au for the adhesion or diffusion barrier.

In an embodiment, the solder, the Au inhibition layer and the UBM may be formed by vacuum deposition, electroplating or electroless plating.

In an embodiment, the patterning may be done by wet-etching, lift-off, printing, ink-jetting, photolithography processes.

In an embodiment, the applications may include 3D IC integration, MEMS packaging for sealing and interconnections, sensors, photonics packaging, automotive electronics.

In an embodiment, In—Sn alloy on Au may be used for development of a transient liquid phase (TLP) bonding at a low temperature of below about 200° C. TLP bonding may form robust intermetallics (IMC) joints with high re-melting temperature (>300° C.) in bonding, so that the IMC joints may withstand a subsequent high temperature process without any degradation. The AuInSn IMC interconnects may be formed by the bonding at about 180° C. for about 20 to 45 s followed by annealing at about 120° C. for about 1 to 12 hours. Through the evaluation in terms of microstructure and compositional observations with scanning electron microscope (SEM) and transmittance electron microscope (TEM), the AuInSn IMC interconnects may include Au_{0.35 to 0.95}(In_{0.75 to 0.95}Sn)_{0.05 to 0.75}. This AuInSn IMC may be found to have a re-melting temperature of above about 400° C. by using Differential Scanning calorimetery (DSC) and Thermo-Mechanical Analysis (TMA). The IMC joint may show a high bonding shear strength (>20 MPa) and a low electrical resistance (<10 mΩ. The young's modulus may be about 70 to 80 GPa which may be much lower than CuSn IMC. This may be an advantage for the 3D IC integration application in the point of lower stress accumulation. The feasibility for its application to the IC stacking may be confirmed by using 3 stacked dice of about 8×8 mm² size with about 1700 I/Os of 80 μm solder bumps. All joints over the die may be uniformly made in each layer with the high bonding strength of about 50 MPa and passed the 3 times reflow test at about 260° C. without delaminating and any changes in the characteristics.

In an embodiment, the composition of the AuInSn IMC joint may be Au_{0.35 to 0.95}(In_{0.75 to 0.95}Sn)_{0.05 to 0.75} with Cu, Ni, Ti, Ag, Pd, Al by replacing-Au atom sites.

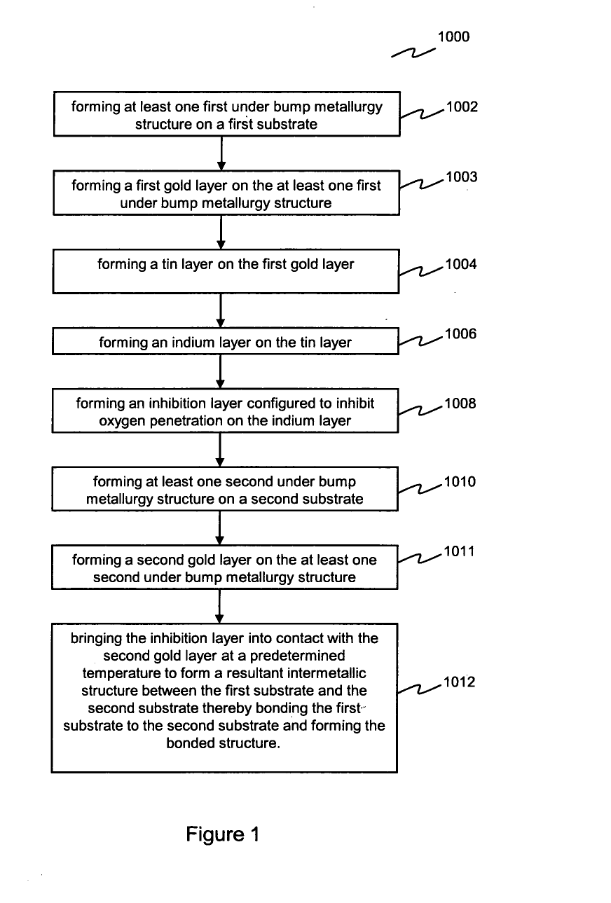

FIG. 1 shows a flowchart 1000 illustrating a method of forming a bonded structure 126 according to an embodiment.

At 1002, at least one first under bump metallurgy (UBM) structure 106 may be formed on a first substrate 102.

At 1003, a first gold layer 118 may be formed on the at least one UBM structure 106.

At 1004, a tin layer 108 may be formed on the first gold layer 118.

At 1006, an indium layer 110 may be formed on the tin layer 108.

At 1008, an inhibition layer 112 configured to inhibit oxygen penetration may be formed on the indium layer 110.

At 1010, at least one second under bump metallurgy (UBM) structure 114 may be formed on a second substrate 104.

At 1011, a second gold layer 122 may be formed on the at least one second UBM structure 114.

At 1012, the inhibition layer 112 may be brought into contact with the second gold layer 122 at a predetermined temperature to form a resultant intermetallic structure 116 between the first substrate 102 and the second substrate 104 thereby bonding the first substrate 102 to the second substrate 104 and forming the bonded structure 126.

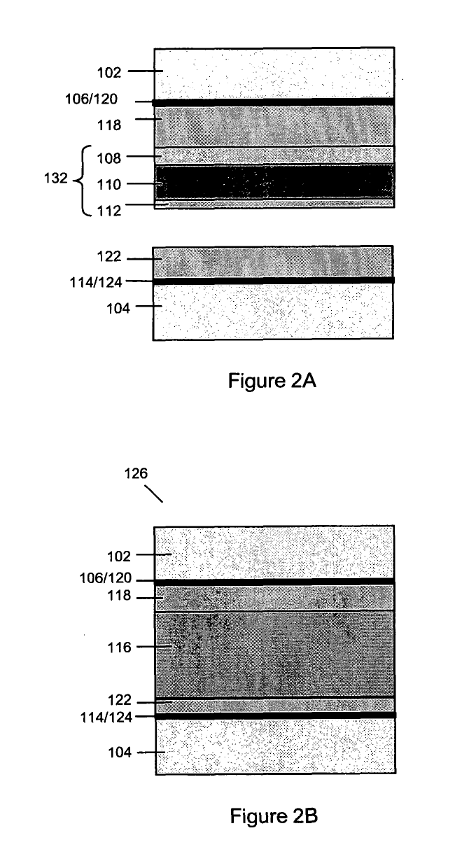

FIG. 2A shows a cross-sectional view of a first substrate 102 and a second substrate 104 before bonding the first substrate 102 to the second substrate 104 according to an embodiment.

In FIG. 2A, at least one first under bump metallurgy (UBM) structure 106 may be formed on the first substrate 102. Next, a first gold layer 118 may be formed on the at least one first UBM structure 106. Then, a tin (Sn) layer 108 may be formed on the first gold layer 118. Further, an indium (In) layer 110 may be formed on the tin layer 108. In addition, an inhibition layer 112 configured to inhibit oxygen penetration may be formed on the indium layer 110. Then, at least one second under bump metallurgy (UBM) structure 114 may be formed on the second substrate 104. And a second gold layer 122 may be formed on the at least one second UBM structure 114.

In an embodiment, the combination of the Sn layer 108, the In layer 110 and the inhibition layer 112 may be termed the initial solder structure 132. The material composition of the initial solder structure 132 may affect the composition of the resultant intermetallic structure 116 as shown in FIG. 2B.

In an embodiment, the inhibition layer 112 may include a material selected from a group of materials consisting of gold (Au), silver (Ag), platinum (Pt), cobalt (Co). The inhibition layer 112 may be configured to inhibit oxygen penetration.

The at least one first under bump metallurgy structure 106 may include a third gold layer (not shown). The at least one first under bump metallurgy structure 106 may further include a first titanium layer 120. The first titanium layer 120 may be positioned directly or indirectly on the first substrate 102. The third gold layer may be positioned directly or indirectly on the first titanium layer 120 and the third gold layer may serve as a seed layer for subsequent deposition of the first gold layer 118. As an example, the first gold layer 118 and the third gold layer may be formed as a single layer. The first titanium layer 120 may be optional. If the first titanium layer 120 may not be present, the third gold layer or the first gold layer 118 may be positioned directly on the first substrate 102.

The at least one second under bump metallurgy structure 114 may include a fourth gold layer (not shown). The at least one second under bump metallurgy structure 114 may further include a second titanium layer 124. The second titanium layer 124 may be positioned directly or indirectly on the second substrate 104. The fourth gold layer may be positioned directly or indirectly on the second titanium layer 124 and the fourth gold layer may also serve as a seed layer for subsequent deposition of the second gold layer 122. As an example, the second gold layer 122 and the fourth gold layer may be formed as a single layer. The second titanium layer 124 may be optional. If the second titanium layer 124 may not be present, the fourth gold layer or the second gold layer 122 may be positioned directly on the second substrate 104.

In an embodiment, the material composition and dimensions of the first gold layer 118 may be the same as the second gold layer 122. Similarly, the material composition and dimensions of the first titanium layer 120 may be the same as the second titanium layer 124. The same may applied for the third gold layer and the fourth gold layer.

In an embodiment, the at least one first under bump metallurgy structure 106 may be the same as the at least one second under bump metallurgy structure 114.

In an embodiment, the at least one first under bump metallurgy structure 106 or the at least one second under bump metallurgy structure 114 may include any suitable material or combination of materials or any suitable number of layers of material depending on design and user requirements.

In an embodiment, the first substrate 102 may include silicon, glass, ceramic, plastic, silicon carbide (SiC), printed circuit board (PCB). The second substrate 104 may include silicon, glass, ceramic, plastic, silicon carbide (SiC), printed circuit board (PCB). Each of the first substrate 102 or the second substrate 104 may include a relatively rigid material suitable for subsequently stacking.

In an embodiment, each of the first substrate 102 or the second substrate 104 may include a wafer or a die.

In an embodiment, the material and dimensions of the first substrate 102 may be the same as the second substrate 104.

In an embodiment, the inhibition layer 112 may include a thickness in the range of about 30 nm to 100 nm.

In an embodiment, the indium layer 110 may include a thickness in the range of about 2t um to 4t um (t≧0.5), for example about 1.0 um to 2 um.

In an embodiment, the tin layer 108 may include a thickness in the range of about t um, for example t≧0.5 um.

In an embodiment, the first gold layer 118 may include a thickness in the range of about 2t um to 3t-um (t≧0.5), for example about 1 um to 1.5 um.

In an embodiment, the first titanium layer 120 may include a thickness in the range of about 50 nm to 200 nm, for example, 100 nm.

In an embodiment, the second gold layer 122 may include a thickness in the range of about 1 um to 3 um.

In an embodiment, the second titanium layer 124 may include a thickness in the range of about 30 nm to 200 nm, for example 100 nm.

In an embodiment, the first gold layer 118 may include a thickness at least two times the thickness of the tin layer 108.

In an embodiment, the indium layer 110 may include a thickness at least double two times the thickness of the tin layer 108. As an example, the thickness of the first gold layer 118 and the thickness of the indium layer 110 may not be the same.

In an embodiment, the first gold layer 118, the tin layer 108 and the indium layer 110 may include a thickness with a ratio selected from a group of ratios consisting of 2:1:3, 3:1;3, 2:1:4, 3:1:4.

FIG. 2B shows a cross-sectional view of a bonded structure 126 after bonding the first substrate 102 to the second substrate 104 according to an embodiment.

The inhibition layer 112 as shown in FIG. 2A may be brought into contact with the second gold layer 122 as shown in FIG. 2A at a predetermined temperature to form a resultant intermetallic structure 116 between the first substrate 102 and the second substrate 104 thereby bonding the first substrate 102 to the second substrate 104 and forming the bonded structure 126 as shown in FIG. 2B. The predetermined temperature may be the bonding temperature.

The bonded structure 126 may further include the at least one first under bump metallurgy (UBM) structure 106 and the at least one second UBM structure 114. The at least one first under bump metallurgy structure 106 may include a first titanium layer 120 and the at least one second under bump metallurgy structure 114 may include a second titanium layer 124. The respective thickness of the first titanium layer 120 and the second titanium layer 124 in FIG. 2B may be similar to that in FIG. 2A but the respective resultant thickness of the first gold layer 118, the second gold layer 122, the third gold layer (not shown) and the fourth gold layer (not shown) in FIG. 2B may be reduced compared to that in FIG. 2A due to the reaction of the respective first gold layer 118, the second gold layer 122, the third gold layer and the fourth gold layer with the In layer 110, the Sn layer 108 and the inhibition layer 112 at the predetermined temperature to form the resultant intermetallic structure 116.

In an embodiment, the resultant intermetallic structure 116 may include a gold-indium-tin intermetallic. The gold-indium-tin intermetallic may be represented by AuInSn IMC or Aux(InSn)1-x (0.35≦x≦0.95).

In an embodiment, the resultant intermetallic structure 116 may include a material with a melting point higher than each of the tin layer 108 or the indium layer 110. The melting point of tin layer 108 may be about 232° C. and the melting point of In layer 110 may be about 156° C.

In an embodiment, the resultant intermetallic structure 116 may include a thickness in the range of about 3 μm to 4 μm depending on the initial solder structure 132.

In an embodiment, the predetermined temperature may be about 180° C. The predetermined temperature may be higher than the melting point of the In layer 110 and lower than the melting point of the Sn layer 108. But the predetermined temperature may be selected such that the temperature is higher than the melting point of an intermediate compound formed when the Sn layer 108 reacts with the In layer 110. The intermediate compound may be InₓSn_{y} with a melting point less than the melting point of the In layer 110.

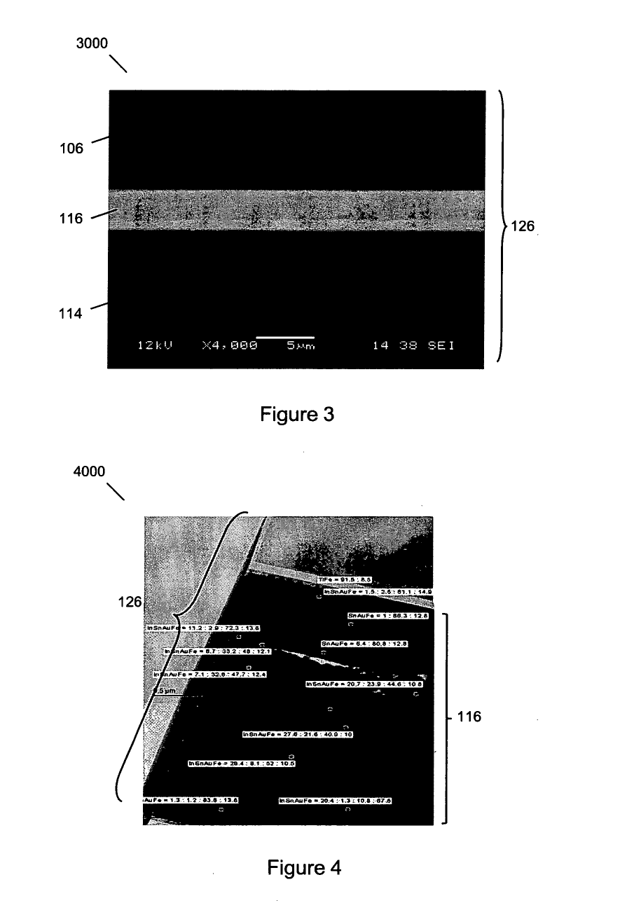

FIG. 3 shows a scanning electron microscope (SEM) image 3000 of a bonded structure 126 according to an embodiment. The bonded structure 126 may include a resultant intermetallic structure 116 between the first under bump metallurgy structure 106 and the second under bump metallurgy structure 114.

The resultant intermetallic structure 116 may include a gold-indium-tin (AuInSn) intermetallic (IMC) or alloy. The first under bump metallurgy structure 106 may include a third gold layer (not shown) and a first titanium layer (not shown). The second under bump metallurgy structure 114 may include a fourth gold layer (not shown) and a second titanium layer (not shown).

FIG. 4 shows a transmission electron microscope (TEM) image 4000 of a bonded structure 126 according to an embodiment.

The bonded structure 126 may include a resultant intermetallic structure 116 between the first under bump metallurgy structure (not shown) and the second under bump metallurgy (not shown).

The resultant intermetallic structure 116 may include a gold-indium-tin (AuInSn) intermetallic (IMC) or alloy.

The resultant intermetallic structure 116 may be positioned between the resultant first gold layer (not shown) and the second gold layer (not shown).

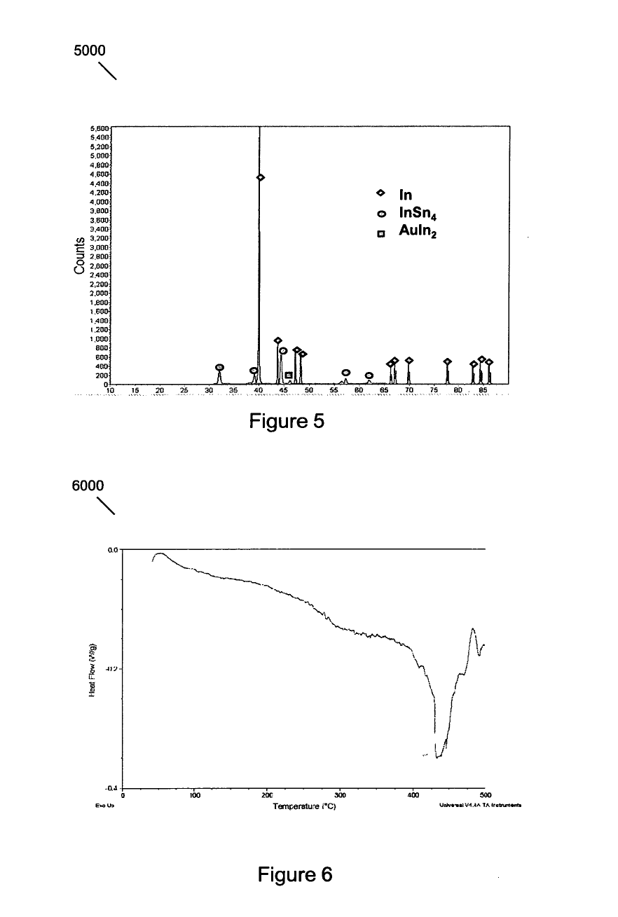

FIG. 5 shows a X-ray diffraction (XRD) 5000 of an unbonded structure after a duration of about 6 months according to an embodiment.

FIG. 5 shows In layer 110 (pure In) remaining which may not have reacted with the first gold layer 118 when forming the resultant intermetallic structure 116 between the first substrate 102 and the second subtrate 104.

The XRD 5000 in FIG. 5 may serve to clarify that even after a duration of about 6 months, there may be sufficient In layer 110 left in the initial solder structure 132 (i.e. solder stack) before bonding. FIG. 5 also serves to show that the Sn layer 108 may be effective as a diffusion controlled layer between the first gold layer 118 and the In layer 110. If there is no Sn layer 108, then the Au atoms within the first gold layer 118 may diffuse into the In layer 110 and one may see a relatively large peak of AuIn₂ instead of an In peak. The AuIn₂ peak seen in the XRD graph 5000 of FIG. 5 may be due to the diffusion of Au from the inhibition layer 112 (i.e thin gold layer).

The X-axis shows 2-theta angle. The higher the In peak, means more pure unreacted In may be present in the solder or in the resultant intermetallic structure 116.

FIG. 6 shows a differential scanning calorimetry (DSC) 6000 of a bonded structure 126 according to an embodiment.

The differential scanning calorimetry (DSC) may be a thermoanalytical technique in which the difference in the amount of heat required to increase the temperature of a sample and a reference are measured as a function of temperature. Both the sample and reference are maintained at nearly the same temperature throughout the experiment.

From the DSC, FIG. 6 shows the remelting tempterature of the resultant intermetallic structure 116. The dip shows that the melting point of the resultant intermetallic structure 116 may be above 300° C.

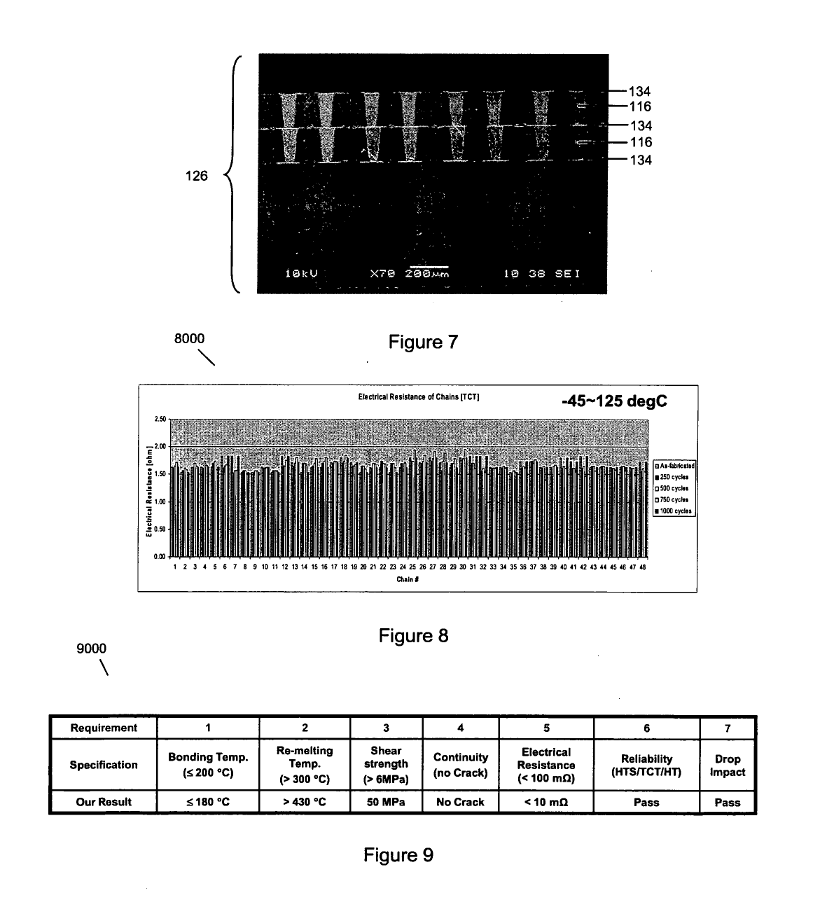

FIG. 7 shows a cross-sectional view of a bonded structure 126 with three substrates 134, each substrate 134 stacked on top of another substrate 134 via respective resultant intermetallic structures 116 according to an embodiment.

Each of the three substrates 134 may include a wafer or a chip. Each of the three substrates 134 may include silicon, glass, silicon carbide (SiC), printed circuit board (PCB) and ceramic.

Each of the resultant intermetallic structure 116 may include a gold-indium-tin (AuInSn) intermetallic (IMC) or alloy. The number of the substrates 134 and the resultant intermetallic structure 116 may vary depending on user and design requirements.

FIG. 8 shows thermal cycling test results 8000 of respective bonded structures 126 at different number of cycles according to an embodiment.

The thermal cycling test (JEDEC standard) may be carried out at a temperature between a range of about 45° C. to about 125° C. The respective thermal cycling test may be carried out for respective bonded structures 126 as fabricated, at 250 cycles, at 500 cycles, at 750 cycles and at 1000 cycles. As the results may be pretty consistent for the different cycles, the bonded structure 126 or the resultant intermetallic structure 116 may be relatively reliable for 3D integration.

FIG. 9 shows three-dimension integration results 9000 of a bonded structure 126 according to an embodiment. A comparison may be made against a requirement for 3D integration as represented by a header “Specification”.

FIG. 9 shows that the bonding temperature when bonding a first substrate 102 to a second substrate 104 may be less than about 180° C. indicating that it may be possible to bond substrates at a relatively low temperature. This may be advantageous for subsequent bonding during stacking of further substrates.

The remelting temperature of the bonded structure 126 may be less than about 430° C. indicating that the resultant intermetallic structure 116 may not melt during subsequent stacking of further substrate.

The shear strength of the bonded structure 126 may be about 50 MPa in an average over more than 10 samples of which the value may be comparable with other IMC joints for example copper-tin (CuSn) IMC joints.

There may not be a crack in the bonded structure 126, indicating relatively good continuity. Presence of cracks in the bonded structure 126 may cause poor reliability.

The electrical resistance of the bonded structure 126 may be less than about 10 mΩ and this may be comparable with conventional interconnect resistance.

The bonded structure 126 may pass the reliability tests for example high temperature storage (HTS), temperature cycling test (TCT) and high temperature (HT). The bonded structure 126 may also pass the drop impact test.

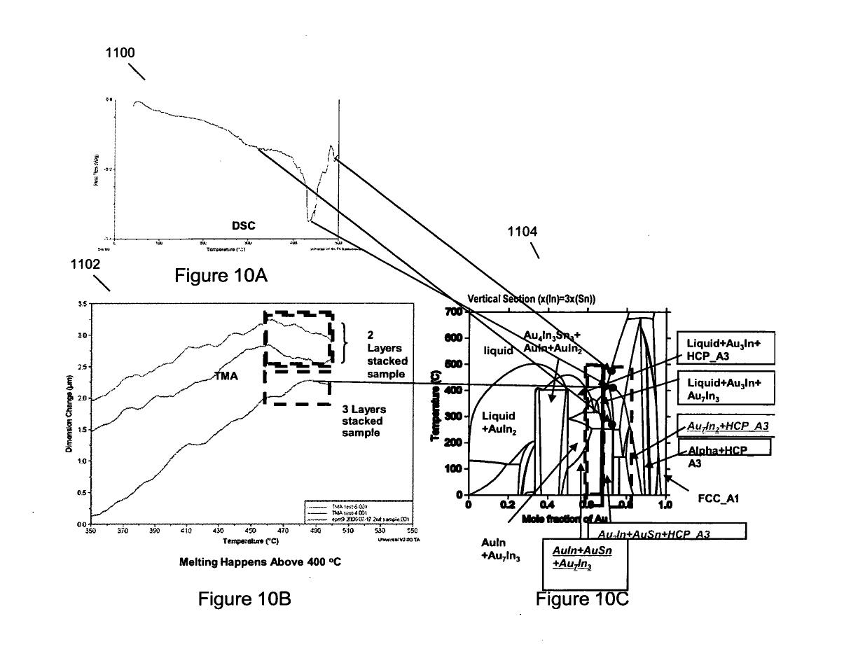

FIG. 10A shows a differential scanning calorimetry (DSC) 1100 of respective bonded structures 126 according to an embodiment.

From the DSC 1100, FIG. 10A may show the melting temperature of the resultant intermetallic structure 116 or IMC joints after bonding.

FIG. 10B shows a thermomechanical analysis (TMA) 1102 of respective bonded structures 126 according to an embodiment.

In FIG. 10B, the TMA 1102 may be measured with stacked dies. The vertical displacement of the stacked die with the resultant intermetallic structure 116 or IMC joints may increase as the temperature may increase. When the resultant intermetallic structure 116 or IMC joints may melt, it may be possible to observe a displacement curve change.

Further in FIG. 10B, all samples under load may expand with temperature until greater than about 450° C. where minute contractions may beobserved. Re-melting temperature may be previously measured at about 400° C. using DSC as shown in FIG. 10A.

FIG. 10C shows a gold-indium-tin ternary phase diagram 1104 according to an embodiment.

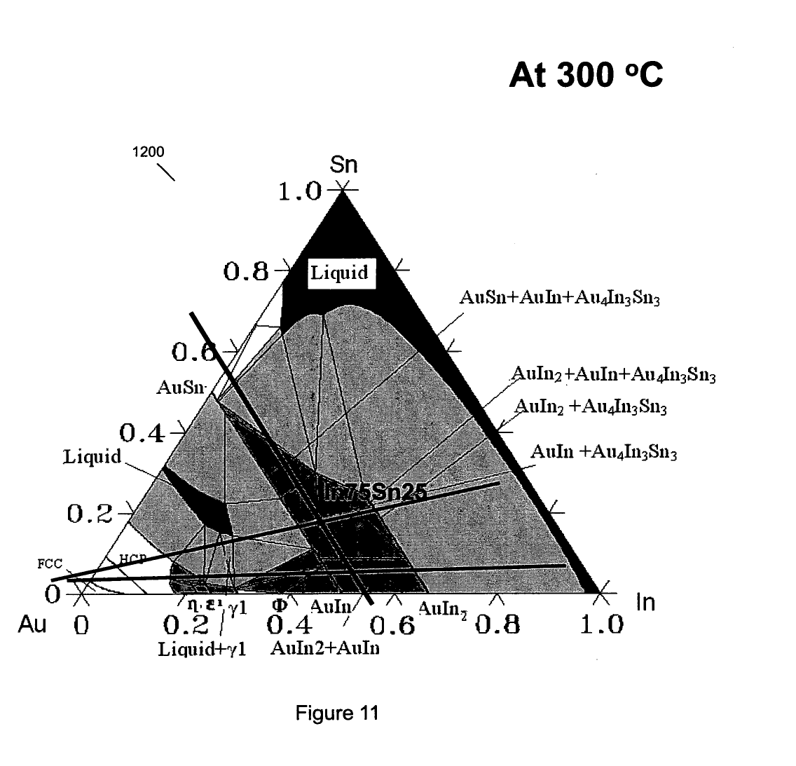

FIG. 11 shows an isothermal gold-indium-tin ternary phase diagram 1200 according to an embodiment. The isothermal gold-indium-tin ternary phase diagram 1200 may be plotted at a temperature of about 300° C. with an optimization of the thermodynamic parameters such as temperature, percentage (%) composition, phases for example.

FIG. 11 may show that at a temperature of about 300° C., the composition range of the respective resultant intermetallic structure or intermediate compound may include solid phase without having liquid phase. The composition range of the respective resultant intermetallic structure or intermediate compound may change when the respective thickness of the individual layers (e.g. first gold layer 118, Sn layer 108, In layer 110, second gold layer 122) changes. Due to change in the layer thickness, the composition of the resulant intermetallic structure may be changed.

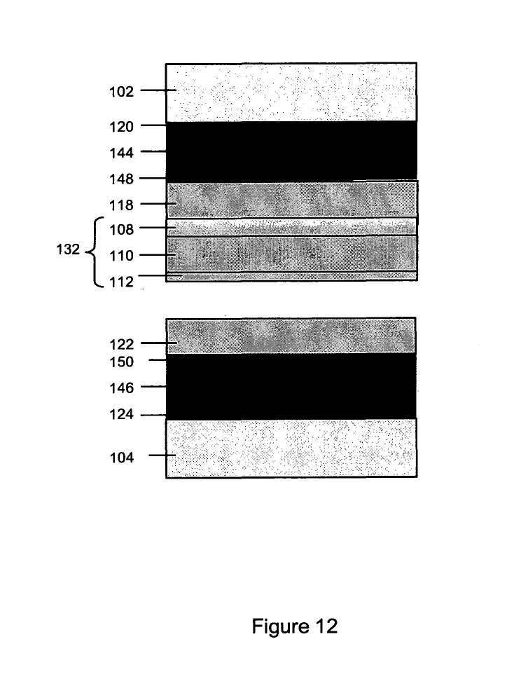

FIG. 12 shows a cross-sectional view of a first substrate 102 and a second substrate 104 before bonding the first substrate 102 to the second substrate 104 according to another embodiment.

FIG. 12 may be similar to FIG. 2A with an addition of a first height-compensation layer 144, a second height-compenstion layer 146, a third titanium layer 148 and a fourth titanium layer 150. The first height-compensation layer 144 may be positioned between the first titanium layer 120 and the first gold layer 118 and the third titanium layer 148 may be positioned between the first height-compensation layer 144 and the first gold layer 118. The second height-compensation layer 146 may be positioned between the second titanium layer 124 and the second gold layer 122 and the fourth titanium layer 150 may be positioned between the second height-compensation layer 146 and the second gold layer 122.

The first height-compensation layer 144 may be the same or different from the second height-compensation layer 146. For example, the second height-compensation layer 146 may be of a same or different material composition or thickness from the first height-compensation layer 144. The first height-compensation layer 144 may include a material selected from a group consisting of copper, tungsten, nickel or silver. Similarly, the second height-compensation layer 146 may include a material selected from a group consisting of copper, tungsten, nickel or silver.

In an embodiment, the third titanium layer 148 may be of the same or different from the fourth titanium layer 150. For example, the third titanium layer 148 may be of a same or different material composition or thickness from the fourth titanium layer 150.

Each of the first height-compensation layer 144 and the second height-compensation layer 146 may serve to increase the distance between the first substrate 102 and the second substrate 104, i.e. to increase the thickness of the subsequent bonded structure (not shown). Therefore, this may serve to increase the height of the bonded structure in cases where susbtrate topography may not be planar while keeping the thickness of the resultant intermetallic structure (i.e. solder thickness) within a specified ratio.

In more details, the first titanium layer 120 may be positioned between the first height-compensation layer 144 and the first substrate 102 and may serve to allow good adhesion between the first height-compensation layer 144 and the first substrate 102 (e.g. Si/SiO₂). Similarly, the second titanium layer 124 may be positioned between the second height-compensation layer 146 and the second substrate 104 and may also serve to allow good adhesion between the second height-compensation layer 146 and the second substrate 104.

The third titanium layer 148 may be positioned between the first height-compensation layer 144 and the first gold layer 118 and may serve to inhibit diffusion of the first height-compensation layer 144 into the first gold layer 118. Thereby, the initial solder structure 132 including the Sn layer 108, the In layer 110 and the inhibition layer 112 may be protected from any diffusion of the first height-compensation layer 144 therein. The fourth titanium layer 150 may be positioned between the second height-compensation layer 146 and the second gold layer 122 and may serve to inhibit diffusion of the second height-compensation layer 146 into the second gold layer 122.

Each of the first titanium layer 120, the second titanium layer 124, the third titanium layer 148 and the fourth titanium layer 150 may be of the same or different material. Further, each of the first titanium layer 120, the second titanium layer 124, the third titanium layer 148 and the fourth titanium layer 150 may be of a same or different dimension or material composition depending on user and design requirements.

In an embodiment, the respective additional first height-compensation layer 144 and the second height-compensation layer 146 may be required only when the respective surfaces of the first substrate 102 (i.e. wafer or chip surface) or the second substrate 104 may not be uniform due to different processes encountered during fabrication or due to presence of some structures on the respective first substrate 102 (wafer or chip) or the second substrate 104. The inclusion of the respective additional first height-compensation layer 144 and the second height-compensation layer 146 may serve to keep the thickness of the resultant intermetallic structure (i.e. AuInSn solder thickness) (not shown) within a certain limit.

Since Au material may be generally be expensive, it may not be feasbile to increase the respective thickness of the first gold layer 118 and the second gold layer 122 with respect to thickness of the respective Sn layer 108 and the In layer 110. As an example, the respective thickness of the first gold layer 118 and the second gold layer 122 between about 1 um to about 1.5 um may generally be acceptable for an initial solder structure 132 including the Sn layer 108 with a thickness of between about 0.5 um to about 1 um and the In layer 110 with a thickness of between about 2 um to about 3 um.

Generally, it may be possible to increase the thickness of the respective Sn layer 108 and the In layer 110 but in order to increase the thickness of the respective first gold layer 118 or the second gold layer 122, there may be a need to pay a relatively high price and therefore the resultant intermetallic structure may become an expensive interconnect. To avoid that, the respective first height-compensation layer 144 and the second height-compensation layer 146 may be introduced which may not affect the solder composition of the initial solder structure 132 and the resultant intermetallic structure 116.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of forming a bonded structure, the method comprising:
forming at least one first under bump metallurgy structure on a first substrate;
forming a first gold layer on the at least one first under bump metallurgy structure;
forming a tin layer on the first gold layer;
forming an indium layer on the tin layer;
forming an inhibition layer configured to inhibit oxygen penetration on the indium layer;
forming at least one second under bump metallurgy structure on a second substrate;
forming a second gold layer on the at least one second under bump metallurgy structure; and
bringing the inhibition layer into contact with the second gold layer at a predetermined temperature to form a resultant intermetallic structure between the first substrate and the second substrate thereby bonding the first substrate to the second substrate and forming the bonded structure.

2. The method of claim 1,
wherein the inhibition layer comprises a material selected from a group of materials consisting of gold, silver, platinum, cobalt.

3. The method of claim 1,
wherein the at least one first under bump metallurgy structure comprises a third gold layer.

4. The method of claim 3,
wherein the first gold layer and the third gold layer are formed as a single layer.

5. The method of claim 3,
wherein the at least one first under bump metallurgy structure further comprises a first titanium layer.

6. The method of claim 1,
wherein the at least one second under bump metallurgy structure comprises a fourth gold layer.

7. The method of claim 6,
wherein the second gold layer and the fourth gold layer are formed as a single layer.

8. The method of claim 6,
wherein the at least one second under bump metallurgy structure further comprises a second titanium layer.

9. The method of claim 1,
wherein the at least one first under bump metallurgy structure is the same as the at least one second under bump metallurgy structure.

10-18. (canceled)

19. The method of claim 1,
wherein the first gold layer comprises a thickness at least two times the thickness of the tin layer.

20. The method of claim 1,
wherein the indium layer comprises a thickness at least two times the thickness of the tin layer.

21. The method of claim 1,
wherein the first gold layer, the tin layer and the indium layer comprises a thickness with a ratio selected from a group of ratios consisting of 2:1:3, 3:1;3, 2:1:4, 3:1:4.

22. The method of claim 1,
wherein the resultant intermetallic structure comprises a gold-indium-tin intermetallic.

23. The method of claim 1,
wherein the resultant intermetallic structure comprises a material with a melting point higher than each of the tin layer or the indium layer.

24. (canceled)

25. The method of claim 5, further comprising:
forming a first height-compensation layer between the first titanium layer and the first gold layer.

26. The method of claim 25, further comprising:
forming a third titanium layer between the first height-compensation layer and the first gold layer.

27. The method of claim 8, further comprising:
forming a second height-compensation layer between the second titanium layer and the second gold layer.

28. The method of claim 27, further comprising:
forming a fourth titanium layer between the second height-compensation layer and the second gold layer.

29. The method of claim 27,
wherein the second height-compensation layer is the same as the first height-compensation layer.

30-31. (canceled)

32. The method of claim 8,
wherein the first titanium layer is the same as the second titanium layer.

33-34. (canceled)
